(19) United States
(12) Patent Application Publication
(10) Pub. No.: US 2010/0225572 A1
(43) Pub. Date: Sep. 9, 2010

(54) ILLUMINATION DEVICE AND LIQUID CRYSTAL DISPLAY DEVICE

(76) Inventors: Shinji Suminoe, Osaka (JP); Yuhsaku Ajichi, Osaka (JP)

Correspondence Address: NIXON & VANDERHYE, PC, 901 NORTH GLEBE ROAD, 11TH FLOOR, ARLINGTON, VA, 22203, US

(21) Appl. No.: 12/599,853

(22) PCT Filed: Jul. 16, 2008
(86) PCT No.: PCT/JP2008/062850

§ 371 Date: Nov. 12, 2009

(30) Foreign Application Priority Data
Aug. 7, 2007 (JP) 2007-205742
Feb. 5, 2008 (JP) 2008-025689

(51) Int. Cl. G09G 3/36; G02F 1/13357

(52) U.S. Cl. 345/102; 362/97.1

(57) ABSTRACT

A backlight (illumination device; 2) of the present invention includes: multiple light sources (5); and multiple light guides (7, 17, . . . ) for causing surface emission of light from the light sources (5). Each of the light guides (7, 17, . . . ) includes: a light-emitting section (7b, 17b, . . . ) having a light-emitting surface (7a); and a light guide section (7c) for guiding, to the light-emitting section (7b, 17b, . . . ), light from the light sources (5), a light-emitting section (7b) of a first light guide (7) being provided above a light guide section (17c) of a second light guide (17) adjacent to the first light guide (7). A light amount adjusting section (11) for reducing the amount of light incident on it is provided between the light-emitting section (7b) of the first light guide (7) and the light-emitting section (17b) of the second light guide. This allows for production of an illumination device having further improved luminance uniformity.

### TECHNICAL FIELD

The present invention relates to an illumination device used, for example, as a backlight of a liquid crystal display device, and also relates to a liquid crystal display device including the illumination device.

### BACKGROUND ART

Liquid crystal display devices have become rapidly popular in place of cathode ray tube (CRT) based display devices in recent years. The liquid crystal display devices have been in widespread use in liquid crystal televisions, monitors, mobile phones, and the like, which take advantage of, e.g., energy saving, thin, and lightweight features of the liquid crystal display devices. One way to further take advantage of such features is to improve an illumination device (i.e., a so-called backlight) which is provided behind the liquid crystal display device.

The illumination devices are roughly classified into a side light type (also referred to as an edge light type) and a direct type. The side light type is configured such that a light guide is provided behind a liquid crystal display panel and that a light source is provided at a lateral edge of the light guide. Light emitted from the light source is reflected by the light guide, so as to irradiate the liquid crystal display panel indirectly and uniformly. With this configuration, it is possible to realize an illumination device which has a reduced thickness and excellent luminance uniformity, although its luminance is low. For this reason, the side light type illumination device is mainly used in medium- to small-size liquid crystal displays such as a mobile phone and a laptop personal computer.

One example of the side light type illumination device is the one disclosed in Patent Literature 1. Patent Literature 1 discloses a surface-emitting device in which a reflecting surface of a light guide plate is provided with a plurality of dots for the purpose of allowing for uniform light emission from a light-emitting surface. In this surface-emitting device, light is not transmitted to a corner section of the reflecting surface due to directivity of a light source, and thereby the corner section of the reflecting surface is darkened, in order to deal with this, the corner section has a higher dot-density compared with other sections.

The direct type illumination device is provided with a plurality of light sources aligned behind a liquid crystal display panel, so as to directly irradiate the liquid crystal display panel. This makes it easier to obtain a high luminance even with a large screen. On this account, the direct type illumination device is mainly employed in a large liquid crystal display of 20 inches or more. However, a currently-available direct type illumination device has a thickness of as much as approximately 20 mm to approximately 40 mm, and this becomes an obstacle to a further reduction in a thickness of the display.

The further reduction in the thickness of the large liquid crystal display can be achieved by shortening a distance between the light source and the liquid crystal display panel. In this case, however, it is impossible for the illumination device to achieve luminance uniformity unless the number of light sources is increased. However, increasing the number of light sources increases a cost. In view of this, there is a need for developing an illumination device which is thin and has excellent luminance uniformity, without increasing the number of light sources.

Conventionally, in order to solve these problems, such an attempt has been conducted that a plurality of side light type illumination devices are aligned and thereby the thickness of the large liquid crystal display is reduced.

For example, Patent Literature 2 proposes a planar light source device that can secure a wide light-emitting area with a compact structure and therefore can be suitably used in a large liquid crystal display. This planar light source device has a tandem structure in which board-shaped light guide blocks are aligned tandemly and each of the light guide blocks is provided with a first light source for supplying each of the light guide blocks with first light.

An illumination device configured, as described above, such that a plurality of light-emitting units each of which is made by a combination of a light source and a light guide are aligned is called a tandem type illumination device.

### CITATION LIST

Patent Literature 1

Japanese Patent Application Publication, Tokukai, No. 2003-43266 (Publication Date: Feb. 13, 2003)

Patent Literature 2

Japanese Patent Application Publication, Tokukaihei, No. 11-288611 (Publication Date: Oct. 19, 1999)

Patent Literature 3

Japanese Patent Application Publication, Tokukai, No. 2001-312916 (Publication Date: Nov. 9, 2001)

### SUMMARY OF INVENTION

However, in the illumination device configured by the combination of the light guides and the light sources as described above, aligning the plurality of light guides planerly poses such a problem that luminance still becomes non-uniform because of luminance unevenness caused by bright lines appearing in regions corresponding to joints between the light guides.

The following describes how bright lines occur. FIG. 13 is a cross-sectional view schematically illustrating a configuration of light guides included in a tandem-type backlight. FIGS. 15 and 16 are each a view schematically illustrating traveling directions of light transmitted in the light guides.

As shown in FIG. 13, the tandem-type backlight includes: a first light guide (on a left side in FIG. 13); and a second light guide (on a right side in FIG. 13) that is adjacent to and overlaps with the first light guide with no gap between them. As shown in FIG. 15, most light from each light source is transmitted through a corresponding light guide while being repeatedly subjected to total reflection, and is then emitted from a corresponding light-emitting surface to outside. However, as shown in FIG. 16, part of the light from the light source is subjected to no total reflection in the light guide, and thus directly arrives at an end surface (7e) opposite from the light source. Total reflection does not attenuate such part of the light. Therefore, the part of the light has a high intensity. Consequently, the part of the light emitted from the end surface (7e) appears as a bright line.

In this regard, according to the arrangement of FIG. 13, light is emitted from an end surface (7e) of the second light guide (on the right side in FIG. 13), the end surface being opposite from a corresponding light source. The light then enters the first light guide (on the left side in FIG. 13) and is transmitted through it (indicated by arrows having bold solid lines in FIG. 13). The light is totally reflected in this first light guide and is then emitted from a light-emitting surface of the first light guide. The arrangement of FIG. 13 includes multiple light guides that together form a light-emitting surface having no gap as described above. This prevents occurrence of bright lines and thus allows for uniform luminance.

For actual use, however, light guides are normally so manufactured as to have a minus tolerance in order to, e.g., prevent adjacent light guides from damaging each other, allow illumination devices to have a small thickness, and tolerate manufactural errors. This results in a gap, corresponding to the tolerance, at a joint between the first light guide and the second light guide (see FIG. 14). This causes light emitted from the end surface (7e) of the second light guide, the end surface being opposite from the light source, to partly enter the first light guide and to be partly emitted above (indicated by a bold solid arrow in FIG. 14) without entering the first light guide. As described above, such light emitted, not from the light-emitting surface, but from the end surface (7e) has an amount larger than an amount of light emitted from the light-emitting surface. Therefore, such light has a high intensity. This is a reason why the light emitted above from the end surface (7e) appears as a bright line.

In order to solve the above problem of bright lines, Patent Literature 3, for example, discloses an arrangement including a dot pattern for diffusing light emitted from a light guide plate, the dot pattern being provided throughout between light guides and a diffusing plate. This arrangement allows for diffusion of light that causes bright lines and thus reduces non-uniformity in luminance.

The above arrangement indeed reduces such luminance unevenness caused by bright lines. However, the arrangement causes a new problem of luminance unevenness caused by the pattern of the dots. The dot pattern does have a function of diffusing light for luminance uniformity. However, it is difficult to completely uniform luminance with use of the dot pattern. The dot pattern, which has a dot distribution density that varies depending on a distance from a light source, gives an effect on luminance unevenness.

Patent Literature 3 further discloses an arrangement including a light-blocking layer on the above end surface, from which light that causes bright lines is emitted. This arrangement blocks light from the end surface, the light having a high luminance, and thus prevents the occurrence of bright lines. Unfortunately, this arrangement prevents light from being emitted from the end surface. This causes a dark line in a region corresponding to the end surface and still impedes achievement of uniform luminance.

Using such an illumination device as a backlight in a display device impairs display quality.

The present invention was made in view of the foregoing problems, and an object of the present invention is to provide an illumination device which further improves its luminance uniformity.

In order to solve the above problems, an illumination device of the present invention includes: a plurality of light sources; and a plurality of light guides each for causing surface emission of light received from at least one of the plurality of light sources, a light amount adjusting section for reducing an amount of light transmitted therethrough, the light amount adjusting section being provided between the light guides adjacent to each other.

In order to solve the above problems, an illumination device of the present invention includes: a plurality of light sources; and a plurality of light guides each for causing surface emission of light received from at least one of the plurality of light sources, each of the plurality of light guides including: a light-emitting section having a light-emitting surface; and a light guide section for guiding, to the light-emitting section, the light from the at least one of the plurality of light sources, a light-emitting section of one of any adjacent two of the plurality of light guides being provided above a light guide section of the other of the any adjacent two of the plurality of light guides, said illumination device further comprising: a light amount adjusting section for reducing an amount of light transmitted therethrough, the light amount adjusting section being provided between (i) the light-emitting section of said one of the any adjacent two of the plurality of light guides and (ii) a light-emitting section of said other of the any adjacent two of the plurality of light guides.

As described above, light emitted, not from the light-emitting surface, but from the end surface (7e) of a light guide, the end surface being opposite from the light source, has an amount larger than the amount of light emitted from the light-emitting surface. Therefore, such light has a high luminance. This causes the light emitted from the end surface to appear as a bright line, and thereby causes luminance unevenness.

In this regard, the above arrangement includes, between adjacent light guides, the light amount adjusting section for reducing the amount of light transmitted through it.

This reduces the amount of light emitted from the end surface, and thus reduces luminance of such light to a level lower than a level of luminance of light emitted from the end surface directly to the outside. This in turn reduces the appearance of bright lines. While conventional arrangements block light emitted from such an end surface, the arrangement of the present invention reduces the amount of such light and allows it to be emitted to the outside. This prevents dark lines caused in conventional arrangements.

This consequently improves luminance uniformity as compared to conventional arrangements.

In order to solve the above problems, an illumination device of the present invention includes: a plurality of light sources; and a plurality of light guides each for causing surface emission of light received from at least one of the plurality of light sources, the plurality of light guides being arranged so as not to overlap one another, a light amount adjusting section for reducing an amount of light transmitted therethrough, the light amount adjusting section being provided between the light guides adjacent to each other.

The above arrangement of the light guides allows for production of a tile-type illumination device. The arrangement further allows for achievement of effects similar to the above effects even in a tile-type illumination device. Specifically, the light amount adjusting section is provided between adjacent light guides. This prevents the occurrence of a bright line caused by light having a high intensity, which light is emitted from the end surface of each light guide, which end surface is located at the boundary between two adjacent light guides. This consequently improves luminance uniformity.

The illumination device of the present invention may be arranged such that the light amount adjusting section is so provided on an end surface of each of the plurality of light guides as to cover the end surface, the end surface being located at a boundary between the light guides adjacent to each other.

The above arrangement causes the light amount adjusting section to cover the end surface. This ensures that light from the end surface is emitted onto the light amount adjusting section. In other words, no light emitted from the end surface leaks out directly to the outside without passing the light amount adjusting section. This surely reduces the amount of light causing bright lines, and thereby further improves luminance uniformity.

The illumination device of the present invention may be arranged such that the light amount adjusting section is made of a semi-transmissive material for reducing an amount of light transmitted therethrough.

The illumination device of the present invention may be arranged such that the semi-transmissive material is gray ink. The following is publicly well known: While black ink blocks light, gray ink reduces the amount of light incident on it and then allows the light to pass through it.

The above arrangement thus reduces the amount of light transmitted through the light amount adjusting section, and thereby reduces the appearance of bright lines.

The illumination device of the present invention may be arranged such that the light amount adjusting section has a function of reducing an amount of light transmitted therethrough and a function of reflecting light.

This reduces the amount of light transmitted through the light amount adjusting section and further reflects light emitted onto the light amount adjusting section. This allows for diffusion of more light and thereby further improves luminance uniformity.

A liquid crystal display device of the present invention includes any of the above the illumination devices as a backlight.

According to the above arrangement, the inclusion of one of the illumination devices of the present invention allows for production of a liquid crystal display device having superior luminance uniformity.

Additional objects, features, and strengths of the present invention will be made clear by the description below. Further, the advantages of the present invention will be evident from the following explanation in reference to the drawings.

### BRIEF DESCRIPTION OF DRAWINGS

FIG. 1

FIG. 1 is a cross-sectional view schematically illustrating a configuration of a liquid crystal display device in accordance with a first embodiment of the present invention.

FIG. 2

FIG. 2 is a perspective view schematically illustrating a configuration of a light guide unit included in the liquid crystal display device.

FIG. 3

FIG. 3 is an enlarged cross-sectional view illustrating a part of the liquid crystal display device shown in FIG. 1.

FIG. 4

FIG. 4 is an enlarged perspective view illustrating a part of the liquid crystal display device shown in FIG. 3.

FIG. 5

FIG. 5 is a cross-sectional view schematically illustrating the configuration of a liquid crystal display device in accordance with a second embodiment of the present invention.

FIG. 6

FIG. 6 is an enlarged cross-sectional view illustrating a part of the liquid crystal display device shown in FIG. 5.

FIG. 7

FIG. 7 is a plan view schematically illustrating the configuration of a backlight included in the liquid crystal display device shown in FIG. 5.

FIG. 8

FIG. 8 is a plan view schematically illustrating the configuration of a backlight included in the liquid crystal display device shown in FIG. 5, which backlight has another arrangement.

FIG. 9

(a) is a plan view illustrating a light guide unit included in the liquid crystal display device of FIG. 5, the light guide unit being observed from a liquid crystal display panel. (b) is a plan view illustrating a light guide unit included in the liquid crystal display device of FIG. 5, the light guide unit being observed from the backlight. (c) is a cross-sectional view of the light guide unit shown in (a), taken along line A-A.

FIG. 10

(a) is a view schematically illustrating traveling directions of light from a light source provided on one side (left side) of a light guide unit. (b) is a view schematically illustrating traveling directions of light from a light source provided on the other side (right side) of the light guide unit.

FIG. 11

FIG. 11 is a cross-sectional view schematically illustrating the configuration of a tile-type backlight, in which any two adjacent light guide units are arranged with no gap between them.

FIG. 12

FIG. 12 is a cross-sectional view schematically illustrating the configuration of a tile-type backlight for actual use.

FIG. 13

FIG. 13 is a cross-sectional view schematically illustrating the configuration of light guide units included in a tandem-type backlight.

FIG. 14

FIG. 14 is a cross-sectional view schematically illustrating the configuration of light guide units included in a tandem-type backlight for actual use.

FIG. 15

FIG. 15 is a view schematically illustrating traveling directions of light transmitted in the light guides.

FIG. 16

FIG. 16 is a view schematically illustrating traveling directions of light transmitted in the light guides.

### DESCRIPTION OF EMBODIMENTS

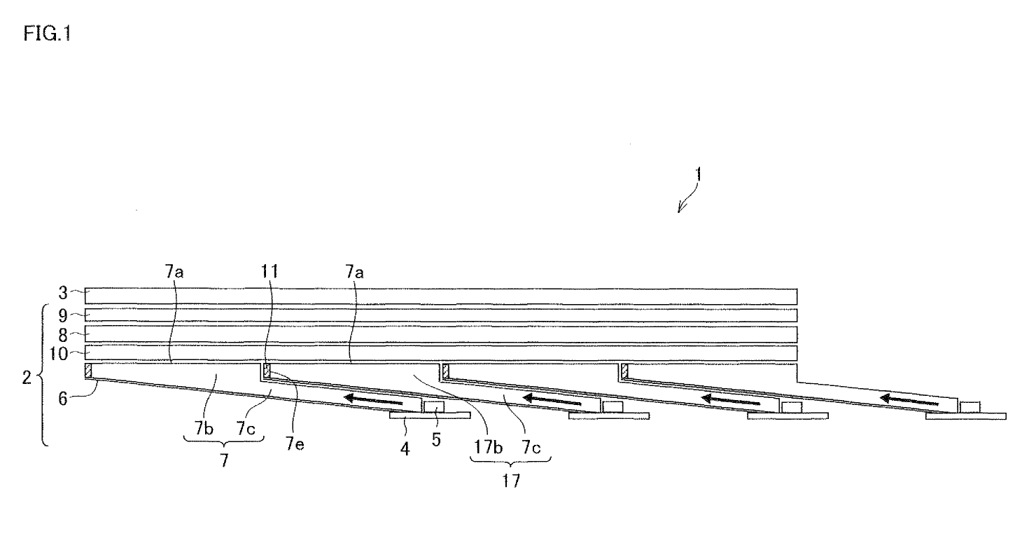

A first embodiment of the present invention is described below with reference to FIGS. 1 through 4. Note that the present invention is not limited to this.

The present embodiment describes an illumination device used as a backlight of a liquid crystal display device.

FIG. 1 is a cross-sectional view schematically illustrating a configuration of a liquid crystal display device 1 according to the present embodiment. The liquid crystal display device 1 includes a backlight 2 (illumination device) and a liquid crystal display panel 3 provided so as to face the backlight 2.

The liquid crystal display panel 3 is similar to a generally-used liquid crystal display panel used in a conventional liquid crystal display device. For example, the liquid crystal display panel 3 is configured so as to include: an active matrix substrate on which a plurality of TFTs (thin film transistors) are formed; and a CF substrate facing the active matrix substrate, and further to include a liquid crystal layer sealed between the active matrix substrate and the CF substrate by means of a sealing material, although they are not illustrated.

A configuration of the backlight 2 provided in the liquid crystal display device 1 is described in detail below.

The backlight 2 is provided behind the liquid crystal display panel 3 (on an opposite side of a display surface). As shown in FIG. 1, the backlight 2 includes substrates 4, light sources 5, reflecting sheets 6, light guides 7, a diffusing plate 8, an optical sheet 9, a transparent plate 10, and a light amount adjusting section 11. Note that the backlight 2 includes at least two light guides. For convenience of explanation, the present embodiment takes a first light guide 7 and a second light guide 17, for example. Also, description of the present embodiment takes the first light guide 7 to represent both light guides 7 and 17, unless otherwise stated.

The light sources 5 are each, for example, a side light-emitting type light-emitting diode (LED) or a cold cathode fluorescent lamp (CCFL). Description herein deals with, as one example, LEDs as the light sources 5. By using, as the light sources 5, the side light-emitting type LEDs each including chips of R, G, and B molded into one package, it is possible to achieve an illumination device capable of a wide range of color reproduction. Note that the light sources 5 are each provided on its corresponding substrate 4.

The light guides 7 each cause surface emission of light from its light-emitting surface 7a, the light having been emitted from its corresponding light source 5. The light-emitting surface 7a is a surface for emitting light toward an irradiation object. In the present embodiment, the light guides 7 employ a tandem configuration as shown in FIG. 1. That is, the light guides 7 are arranged such that: (i) each light guide 7 includes (a) a light-emitting section 7b including the light-emitting surface 7a and (b) a light guide section 7c for directing, to the light-emitting section 7b, light emitted from the corresponding light source 5; (ii) the light-emitting section 7b and the light guide section 7c have different thicknesses at least at a connection between them; and (iii) the light-emitting section 17b of a light guide 17 is placed on the light guide section 7c of another light guide 7. This allows a plurality of light guides 7, 17, . . . to form a flush light-emitting surface (a complete light-emitting surface of the backlight 2 as a whole; a light-emitting region). The end surface 7e of the light-emitting section 7b is located opposite from the light source 5.

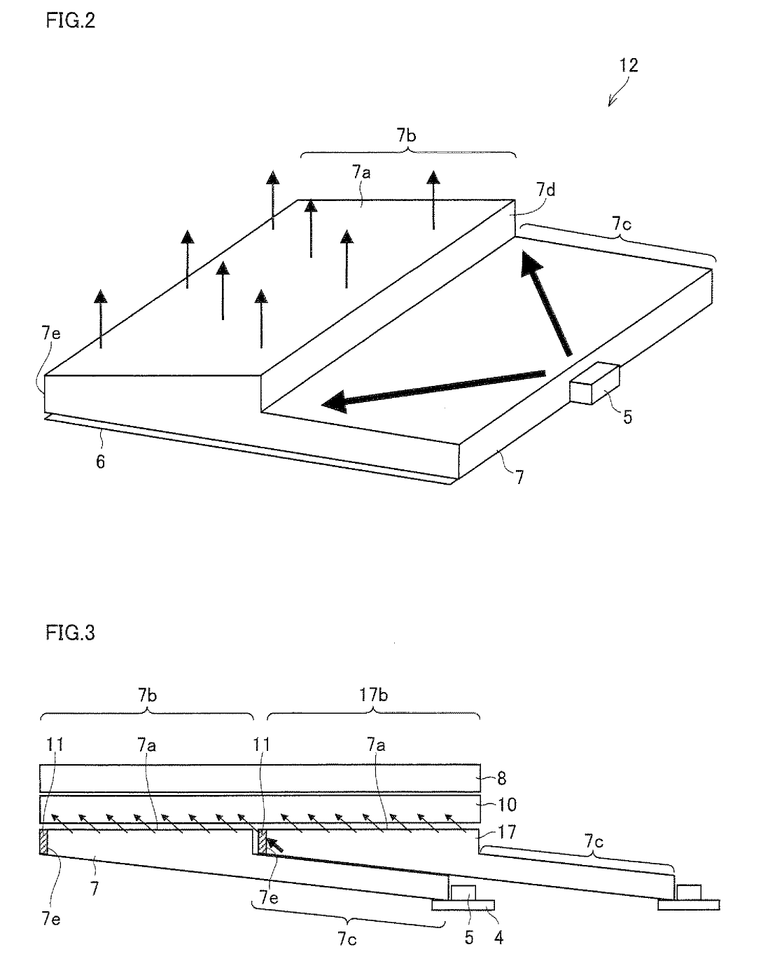

FIG. 2 is a perspective view schematically illustrating a configuration of a light guide unit 12 included in the liquid crystal display device 1 shown in FIG. 1. The light guide unit 12 diffuses light emitted from its light source 5 for plane emission. The light guide unit 12 includes a light source 5, a substrate 4 (see FIG. 1), a reflecting sheet 6, and a light guide 7. As shown in FIG. 2, light emitted from the light source 5 enters the light guide section 7c of the light guide 7. The light is then transmitted through the light guide section 7c, and reaches the light-emitting section 7b. 7a The light-emitting section 7b of the light guide 7 has a front surface (light-emitting surface 7a) or a back surface that has been subjected to a process or a treatment (not shown) for causing light guided as above to be emitted toward the front surface. Thus, the light is emitted from the light-emitting surface 7a of the light guide 7 toward the liquid crystal display panel 3. Examples of a specific method for the process or the treatment applied to the light-emitting section 7b of the light guide 7 encompass prism processing, texturing, and print processing. However, the method is not particularly limited, and may be a publicly known method as needed.

The light guides 7 are mainly made from a transparent resin such as a polycarbonate (PC) or a polymethyl methacrylate (PMMA). However, the material is not particularly limited, but may preferably be a material having a high light transmittance. Further, the light guides 7 may be formed by means of, for example, injection molding, extrusion molding, hot-press molding, or cutting. However, the molding method used in the present invention is not particularly limited to these, and may be any processing method, provided that the method achieves a similar property.

The reflecting sheets 6 are each provided in contact with the back surface (a surface opposite to the light-emitting surface 7a) of the corresponding light guide 7. The reflecting sheets 6 each reflect light so as to allow the corresponding light-emitting surface 7a to emit a larger amount of light. Since the present embodiment includes multiple light guides 7, the reflecting sheets 6 are provided for the light guides 7, 17, . . . individually.

The diffusing plate 8 is so provided as to face the light-emitting surfaces 7a in such a manner as to cover the whole of the flush light-emitting surface (light-emitting region) formed by the light-emitting surfaces 7a of the respective light guides 7, 17 . . . . The diffusing plate 8 diffuses light emitted from the light-emitting surface 7a of each light guide 7 so that the light is emitted onto the optical sheet 9 (described later). The present embodiment uses, as the diffusing plate 8, “SUMIPEX E RMA10” (manufactured by Sumitomo Chemical Co., Ltd.) having a thickness of 2.0 mm. The diffusing plate 8 may be placed a predetermined distance away from the light-emitting surfaces 7a, the predetermined distance being set to 3.0 mm, for example.

The optical sheet 9 is made of a plurality of sheets stacked on one another. The optical sheet 9 is so placed as to face the front surface of each light guide 7. The optical sheet uniforms and condenses light emitted from the light-emitting surface 7a of each light guide 7 so as to emit the light toward the liquid crystal display panel 3. The optical sheet 9 may include: a diffusing sheet for simultaneously condensing and diffusing light; a lens sheet for condensing light so as to improve luminance in a front direction (direction toward the liquid crystal display panel); and a polarizing and reflecting sheet for reflecting a polarized component of light having a particular vibration pattern and transmitting other polarized components having other vibration patterns so as to improve luminance of the liquid crystal display device 1. These sheets should preferably be used in combination as needed in accordance with an intended price and/or performance of the liquid crystal display device 1. The present embodiment uses, as an example, “LIGHT-UP 250GM2” (manufactured by Kimoto Co., Ltd.) as the diffusing sheet, “Thick RBEF” (manufactured by Sumitomo 3M Ltd.) as a prism sheet (i.e., the lens sheet), and “DBEF-D400” (manufactured by Sumitomo 3M Ltd.) as a polarizing sheet (polarizing and reflecting sheet).

The transparent plate 10 is used to maintain a distance between the diffusing plate 8 and respective of the light guides 7, and forms a light diffusing region. The transparent plate 10 is made of a light-transmitting material such as a polyethylene film. Alternatively, the light guides 7 can face the diffusing plate 8 instead of providing the transparent plate 10.

The light amount adjusting sections 11 reduce the amount of light incident on them, and emit the light thus reduced to the outside. Thus, the light amount adjusting sections 11 have a function of reducing the amount of transmitting light, and are made of, e.g., a semi-transmissive material. Specifically, the light amount adjusting sections 11 are formed by, for example, printing a pattern in white or gray ink. Alternatively, the light amount adjusting sections 11 may be formed by application or attachment of a half mirror such as a dielectric mirror, a polarizing and reflecting sheet, or a cholesteric liquid crystal layer. The light amount adjusting sections 11 can also be formed by application of a resin having a high refractive index. The light amount adjusting sections 11 are not limited to the examples, provided that they have a function of reducing the amount of light.

With the members, light emitted from the light sources 5 (i) travels in the light guides 7 while being scattered and reflected as shown in FIGS. 2 and 15, (ii) is emitted from the light-emitting surfaces 7a, and (iii) then reaches the liquid crystal display panel 3, via the diffusing plate 8 and the optical sheet 9.

### (Luminance Uniformity)

The following describes a principle on which luminance becomes non-uniform.

As described above with reference to FIG. 15, the light from a light source 5 (i) enters a light guide section 7c of a corresponding light guide 7 at a critical angle, (ii) repeatedly carries out a total reflection in the light guide section 7c and then arrives at a light-emitting section 7b, (iii) is reflected from the reflecting sheet 6 provided on a back surface of the light-emitting section 7b, and (iv) is ultimately emitted from the light-emitting surface 7a. As described above, most of the light emitted from the light source 5 is repeatedly subjected to total reflection within the light guide 7. Therefore, the amount of light from the light source 5 decreases as the light is farther away from the light source 5.

Unfortunately, as shown in FIG. 16, part of the light emitted from the light source 5 is subjected to no total reflection within the light guide 7, and directly arrives at an end surface 7e, which is farther away from the light source 5. Total reflection does not attenuate the part of the light. This causes the part of the light to have an intensity higher than that of the light emitted from the light-emitting surface 7a.

As shown in FIG. 14, the tandem configuration leaves a gap between light-emitting sections of adjacent light guides. This causes part of the light emitted from a light source to be directly emitted to the outside from an end surface 7e of a corresponding light guide. This in turn causes the part of the light having a high intensity to appear as a bright line on the liquid crystal display panel, thereby resulting in non-uniform luminance as a whole.

In view of the circumstances, the present embodiment includes the light amount adjusting sections 11 in order to reduce the amount of light emitted from each of the end surfaces 7e of the respective light guides, the light causing bright lines. The following describes where the light amount adjusting sections 11 are specifically provided.

### (Arrangement of the Light Amount Adjusting Sections 11)

FIG. 3 is an enlarged cross-sectional view of a part of the liquid crystal display device 1 shown in FIG. 1. As shown in FIG. 3, the light amount adjusting sections 11 are each provided in a region defined by a light-emitting section 7b of one of adjacent light guides 7 and a light-emitting section 17b of the other of adjacent light guides 17 so as to receive light emitted, not from a light-emitting surface 7a, but from an end surface 7e of the light guide 17. The end surface 7e is farther away from a corresponding light source 5. In FIG. 3, each of the light amount adjusting sections 11 is provided in contact with an end surface 7e. However, the arrangement is not limited to this. The light amount adjusting sections 11 are each simply required to be provided at such a position in a region defined by adjacent light-emitting sections 7b and 17b as to receive light emitted from an end surface 7e.

This arrangement reduces the amount of the light that is emitted from the light source 5, directly arrives at the end, surface 7e, and is then emitted from the end surface 7e. This in turn reduces the luminance of light emitted from the end surface 7e. This consequently prevents the appearance of bright lines and thus further improves luminance uniformity as compared to conventional arrangements.

As described above, the backlight 2 of the present embodiment effectively uses a region inevitably formed due to a productional restriction (i.e., a gap formed between adjacent light-emitting sections 7b and 17b). This uniquely allows for achievement of luminance uniformity.

Furthermore, the light amount adjusting sections 11 are each provided only between adjacent light-emitting sections 7b and 17b and therefore are not provided in a region between the light-emitting surfaces 7a and the diffusing plate 8. This allows for reduction in the thickness of the backlight 2.

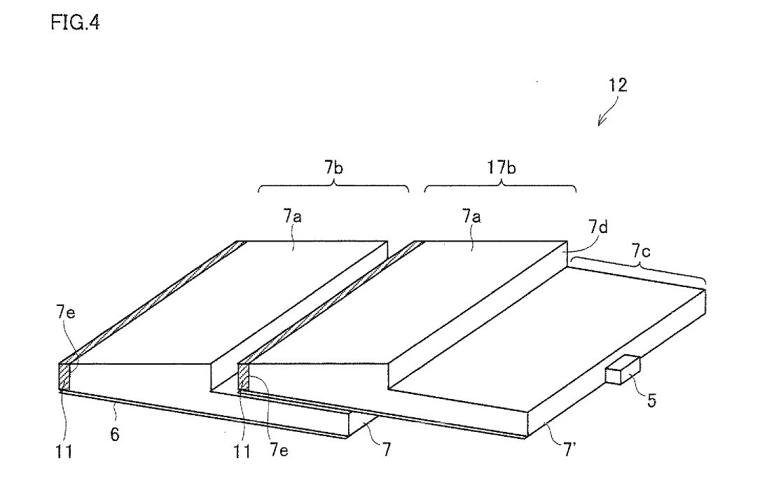

The region defined by respective light-emitting sections 7b and 17b of adjacent light guides 7 and 17 is so formed as to extend in a direction perpendicular to a surface of FIG. 3. Therefore, as shown in FIG. 4, the light amount adjusting sections 11 are each preferably so formed as to extend linearly along the region.

As shown in FIG. 3, the light amount adjusting sections 11 are preferably so provided in contact with respective end surfaces 7e of the light guides as to cover the end surfaces 7e. This reliably causes light emitted from the end surface 7e of each light guide, the end surface 7e being farther away from the corresponding light source 5, to be incident onto the corresponding light amount adjusting section 11. In other words, no light emitted from the end surface 7e directly leaks out, without passing the corresponding light amount adjusting section 11. This reliably reduces the amount of light that causes bright lines and consequently further improves luminance uniformity.

Alternatively, the end surface 7e of each light guide 7 may be treated so as to function as a light amount adjusting section 11. As a specific example, white or gray ink may be applied to the end surface 7e. This arrangement eliminates the need to include light amount adjusting sections as members separate from the light guides 7, and thus allows for downsizing of the backlight 2 and also for reduction in the weight of the backlight 2.

### Embodiment 2

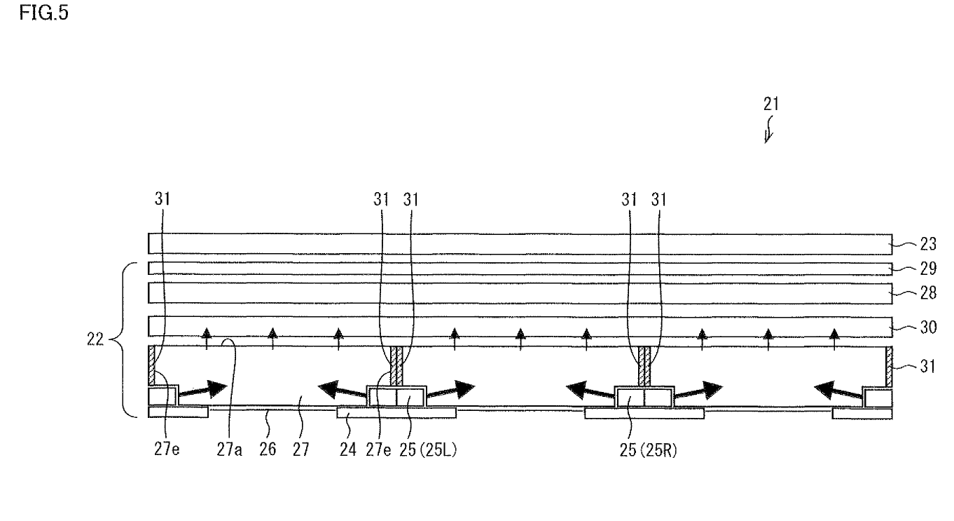

A second embodiment of the present invention is described below with reference to FIGS. 5 through 12.

Embodiment 1 above describes a tandem-type backlight. In contrast, the present embodiment describes a tile-type backlight, which includes multiple light guides that are arranged in a plane and that do not overlap one another.

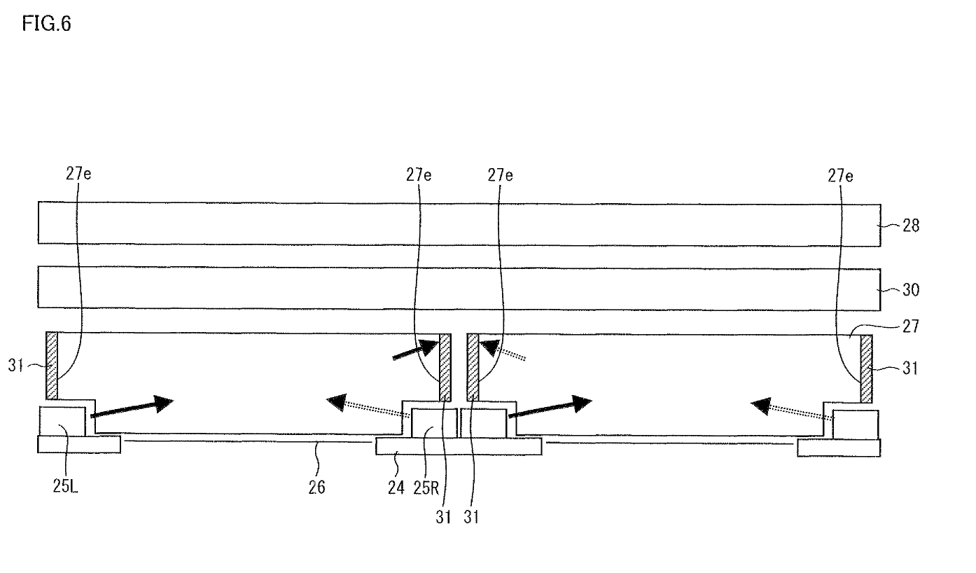

FIG. 5 is a cross-sectional view schematically illustrating a configuration of a liquid crystal display device 21 according to the present embodiment. FIG. 6 is an enlarged cross-sectional view of a part of the liquid crystal display device 21. The liquid crystal display device 21 includes: a backlight 22 (illumination device); and a liquid crystal display panel 23 so provided as to face the backlight 22. The liquid crystal display panel 23 has an arrangement similar to an arrangement of the liquid crystal display panel 3 of Embodiment 1.

The following describes a configuration of the backlight 22 included in the liquid crystal display device 21.

The backlight 22 is disposed behind the liquid crystal display panel 23 (i.e., to face a surface opposite from a display surface of the liquid crystal display panel 23). As shown in FIG. 5, the backlight 22 includes: substrates 24, light sources 25, reflecting sheets 26, light guides 27, a diffusing plate 28, an optical sheet 29, a transparent plate 30, and light amount adjusting sections 31.

The light sources 25 are each, for example, a dot-shaped light source of a side light-emitting type, such as a light-emitting diode (LED). The following description uses, as an example, LEDs as the light sources 25. Use of LEDs of a side light-emitting type as the light sources 25, the LEDs each including chips of R, G, and B molded in one package, allows for production of an illumination device having a wide color reproduction range. The light sources 25 are each disposed on its corresponding substrate 24.

The light guides 27 each cause surface emission, from its light-emitting surface 27a, of light emitted from a corresponding light source 25. The light-emitting surface 27a is a surface for emitting light onto an object.

Other constituent members each have an arrangement substantially identical with an arrangement of its corresponding member included in the backlight 2 of Embodiment 1. Thus, description of them is omitted here.

The backlight 22 of the present embodiment includes at least two light guides 27. More specifically, the backlight 22 includes multiple light guide units 32 arranged in a plane, the light guide units 32 being each formed by combination of a light guide 27 and a light source 25.

As shown in FIGS. 5 and 6, the backlight 22 of the present embodiment includes light guide units 32 so arranged in a plane as not to overlap one another. This allows respective light-emitting surfaces 27a of the multiple light guides 27, 27, . . . to collectively form a flush light-emitting surface (light-emitting surface of the backlight 22 as a whole; light-emitting region).

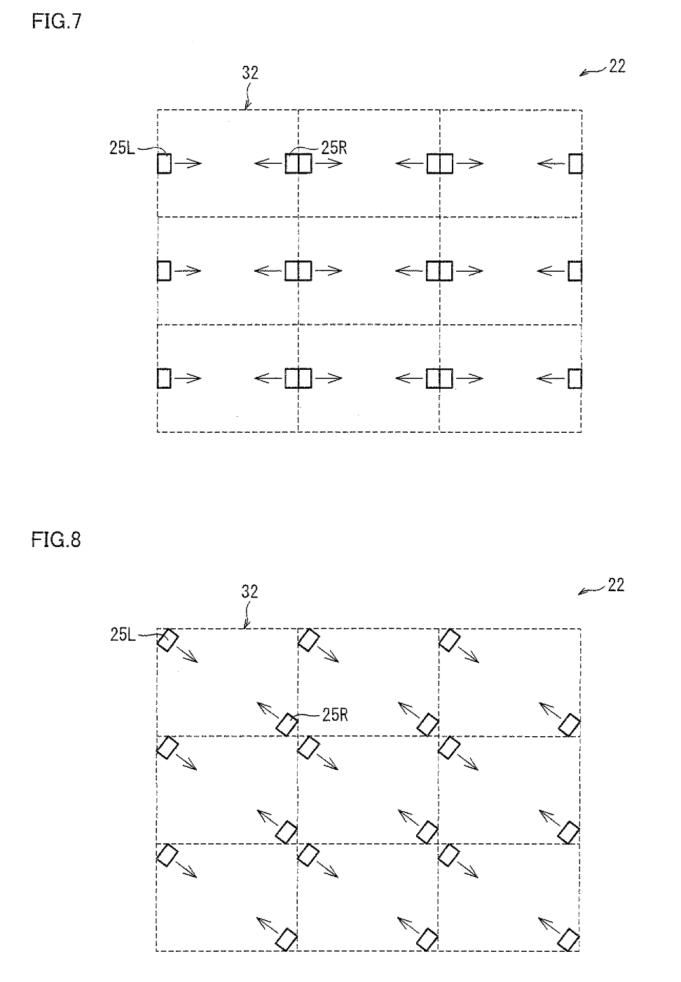

FIG. 7 is a plan view schematically illustrating the configuration of the backlight 22. As shown in FIG. 7, the backlight 22 includes multiple light guide units 32 arranged in a matrix, the light guide units 32 each including two light sources 25L and 25R (a pair of light sources). The backlight 22 of the present embodiment includes multiple light guide units 32 that are, as described above, arranged as if they were tiles that are laid out. The backlight 22 is thus referred to as a tile-type backlight.

FIG. 8 illustrates another example configuration of the backlight 22. The backlight 22 shown in FIG. 7 includes light guide units 32, each of which is rectangular and includes two light sources 25L and 25R each disposed in a vicinity of a middle of one of two opposite sides. In contrast, the backlight 22 shown in FIG. 8 includes light guide units 32, each of which is rectangular and includes two light sources 25L and 25R each disposed at one of two opposite corners connected by a diagonal line.

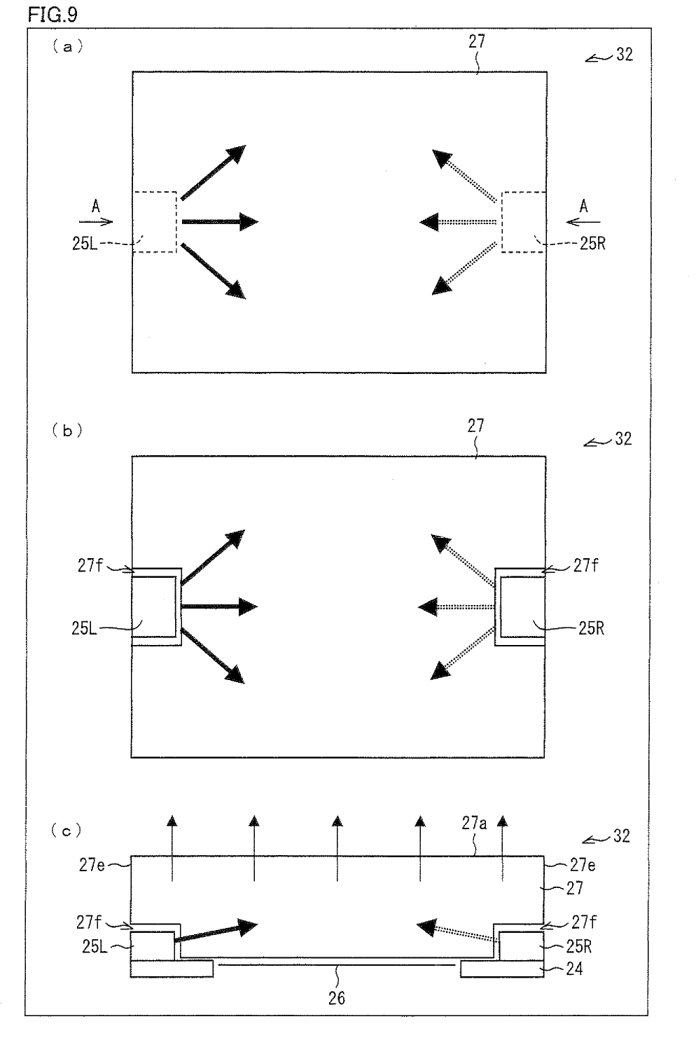

FIG. 9 illustrates an arrangement of a light guide unit 32 included in the backlight 22. FIG. 9 (a) is a plan view (top view) of the light guide unit 32 observed from the liquid crystal display panel 23 (i.e., from above). FIG. 9 (b) is a plan view (bottom view) of the light guide unit 32 observed in a direction opposite from a direction in which the light guide unit 32 is observed in FIG. 9 (a). FIG. 9 (c) is a cross-sectional view of the light guide unit 32 of FIG. 9 (a), taken along line A-A.

The light guide unit 32 shown in FIG. 9 includes: two light sources 25L and 25R; and a light guide 27 for causing surface emission of light from the light sources. The light sources 25L and 25R are each contained in one of hollow recesses 27f provided in the light guide 27. The light sources 25L and 25R face each other. Also, the light sources 25L and 25R are both mounted on a substrate 24. As shown in FIG. 9, the light sources 25L and 25R are set to emit light in such directions (indicated respectively by arrows having solid lines and those having dotted lines) that each of the light sources 25L and 25R emits light toward, the other.

In other words, the light guide unit 32 includes the two opposite dot-shaped light sources in such complementary positions that each of the light sources irradiates a region that is incapable of being irradiated by the other light source.

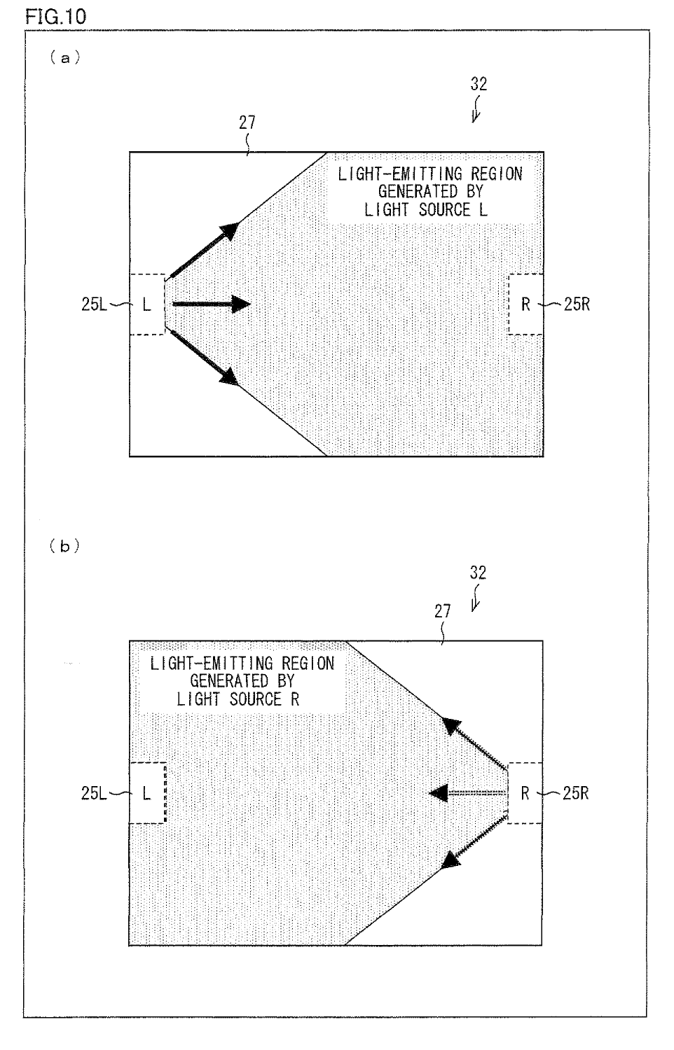

FIG. 10 schematically illustrates traveling directions of light from the light sources 25L and 25R included in the light guide unit 32. FIG. 10 (a) illustrates traveling directions of light from the light source 25L disposed on a left side of the light guide unit as viewed from above. FIG. 10 (b) illustrates traveling directions of light from the light source 25R disposed on a right side of the light guide unit as viewed from above.

As shown in FIG. 10, the light sources 25L and 25R are so disposed as to face each other in such positions that light from each of the light sources travels through the light guide 27. As such, combining respective light-emitting regions generated by the light sources allows for light emission from the entire light-emitting surface 27a of the light guide 27. In the present embodiment, arranging multiple light guide units 32 described above allows for production of a large backlight that is free from dark portions.

As shown in FIG. 5, the light emitted from the light sources 25 as described above (i) is transmitted through the light guides 27 while being diffused and reflected, (ii) is emitted from the light-emitting surfaces 27a, (iii) travels through the diffusing plate 28 and the optical sheet 29, and (iv) arrives at the liquid crystal display panel 23.

### (Luminance Uniformity)

As in a tandem-type backlight, a tile-type backlight also poses a problem of bright lines on a display panel, the problem being caused by a gap between each two adjacent light guides. The bright lines impair luminance uniformity. The following describes a principle on which luminance is rendered non-uniform.

As described with reference to FIG. 15, most light from each of the light sources 25 is repeatedly subjected to total reflection in a corresponding light guide 27 and then is emitted from a corresponding light-emitting surface 27a. However, as in the case of FIG. 14, part of the light from each of the light sources 25 is subjected to no total reflection in the corresponding light guide 27 and directly arrives at an end surface 27e (see FIG. 9 (c)), which is farther away from the corresponding light source 25. Total reflection does not attenuate such part of the light. This causes the part of the light to have an intensity higher than an intensity of the light emitted from the corresponding light-emitting surface 27a.

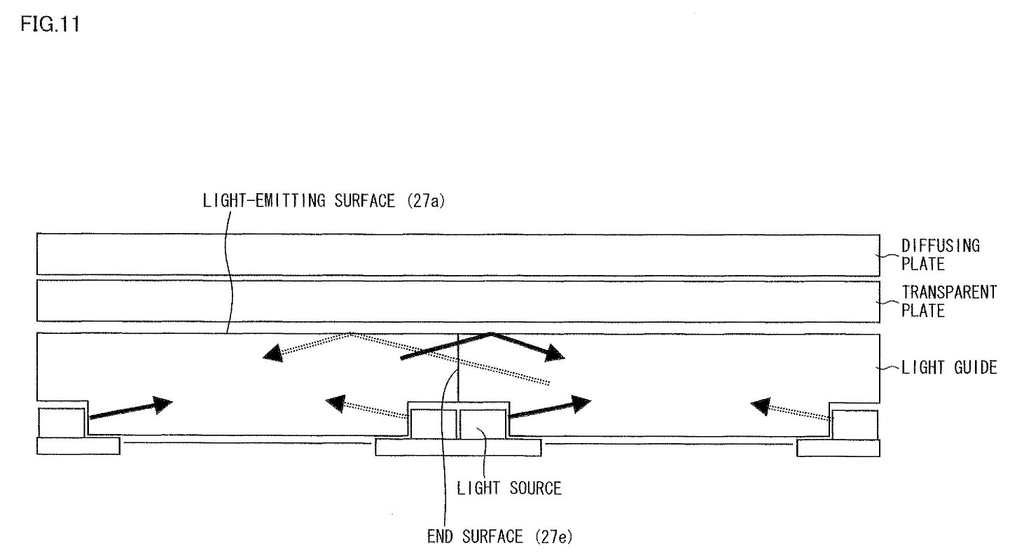

Assume that, as shown in FIG. 11, a first light guide (on a left side in FIG. 11) and a second light guide (on a right side in FIG. 11) adjacent to the first light guide are disposed with no gap between them. In this case, light leaking from an end surface 27e of the first light guide is emitted onto an end surface 27e of the second light guide. The light is then subjected to total reflection in the second light guide and is emitted from its light-emitting surface 27a. This causes no bright line.

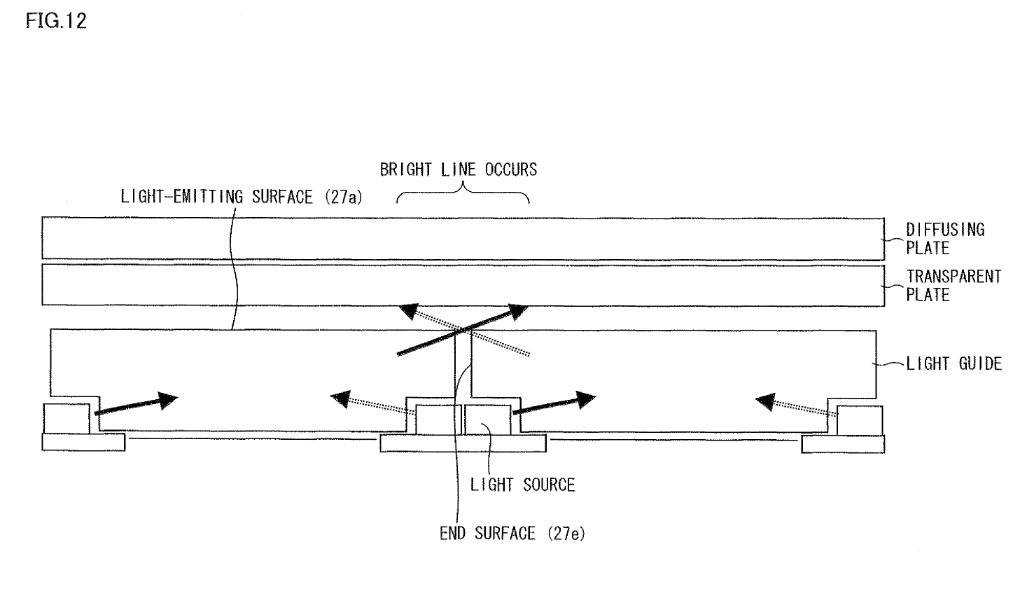

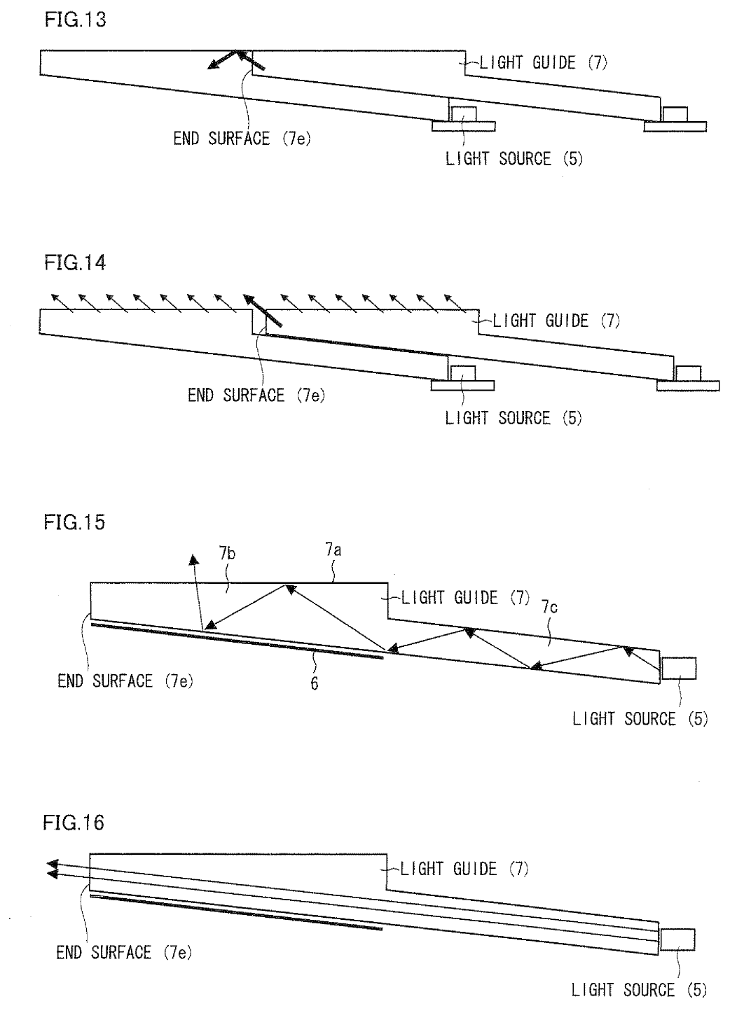

However, as shown in FIG. 12, the first light guide and the second light guide adjacent to the first light guide are, in actual use, separated by a gap along a boundary between them. This causes part of light from each light source to be directly emitted from an end surface 27e of its corresponding light guide to the outside. This in turn causes the part having a high intensity to appear as a bright line, thereby resulting in non-uniform luminance as a whole.

In view of this, as in the arrangement of the backlight 2 of Embodiment 1, the present embodiment includes light amount adjusting sections 31 so as to reduce an amount of light emitted from the end surface 27e of each of the light guide. As shown in FIGS. 5 and 6, each of the light amount adjusting sections 31 is disposed between two adjacent light guides 27 and 27.

The light amount adjusting sections 31 are positioned as specified in the description of the backlight 2 of Embodiment 1. Specifically, the light amount adjusting sections 31 may be so provided in contact with respective end surfaces 27e of the light guides 27 as to cover the end surfaces 27e. Alternatively, white or gray ink may be applied to the end surface 27e of each light guide 27 so that light amount adjusting sections 31 are formed.

The respective light amount adjusting sections 11 and of the arrangements of Embodiments 1 and 2 each preferably have not only a function of reducing the amount of transmitting light, but also a function of reflecting incident light. The light amount adjusting sections 11 and 31, which are capable of reducing the amount of incident light and reflecting such light, allow for diffusion of more light. This further improves luminance uniformity.

As described above, because the liquid crystal display devices 1 and 21 of the first and second embodiments include the backlights 2 and 22 respectively as described above, the liquid crystal display devices 1 and 21 can emit more uniform light to the liquid crystal display panels 3 and 23 respectively, thereby improving display quality.

Further, because the illumination devices of the present invention have excellent luminance uniformity even in a case of a large light-emitting area, it is particularly preferable that the illumination devices are each used as a backlight of a liquid crystal display device having a large screen. However, the present invention is not limited to this, and may be used as a backlight of any liquid crystal display panel.

As described above, illumination devices of the present invention each include light amount adjusting sections which reduce the amount of transmitting light. The light amount adjusting sections are each disposed between adjacent light guides.

The above arrangement allows for production of an illumination device having further improved luminance uniformity.

As described above, a liquid crystal display device of the present invention includes one of the illumination devices of the present invention as a backlight.

The above arrangement allows light to be emitted more uniformly onto the liquid crystal display panel. This improves display quality.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

### INDUSTRIAL APPLICABILITY

The illumination devices of the present invention are each applicable as a backlight of a liquid crystal display device. In particular, the illumination devices of the present invention are each suitably applicable as a backlight of a large liquid crystal display device.

### REFERENCE SIGNS LIST

1, 21 Liquid crystal display device
2, 22 Backlight (Illumination device)
3, 23 Liquid crystal display panel
4, 24 Substrate
5 Light source (LED, Cold cathode fluorescent tube)
25 (25L, 25R) Light source (LED)
6, 26 Reflecting sheet
7, 17, 27 Light guide
7a, 27a Light-emitting surface (of a light guide)
7b, 17b Light-emitting section
7c Light guide section
7e, 27e End surface
8, 28 Diffusing plate
9, 29 Optical sheet
10, 30 Transparent plate
11, 31 Light amount adjusting section
12, 32 Light guide unit

1. An illumination device comprising:
a plurality of light sources; and
a plurality of light guides each for causing surface emission of light received from at least one of the plurality of light sources,
a light amount adjusting section for reducing an amount of light transmitted therethrough, the light amount adjusting section being provided between the light guides adjacent to each other.

2. An illumination device comprising:
a plurality of light sources; and
a plurality of light guides each for causing surface emission of light received from at least one of the plurality of light sources,
each of the plurality of light guides including:
a light-emitting section having a light-emitting surface; and
a light guide section for guiding, to the light-emitting section, the light from the at least one of the plurality of light sources,
a light-emitting section of one of any adjacent two of the plurality of light guides being provided above a light guide section of the other of the any adjacent two of the plurality of light guides,
said illumination device further comprising:
a light amount adjusting section for reducing an amount of light transmitted therethrough, the light amount adjusting section being provided between (i) the light-emitting section of said one of the any adjacent two of the plurality of light guides and (ii) a light-emitting section of said other of the any adjacent two of the plurality of light guides.

3. An illumination device comprising:
a plurality of light sources; and
a plurality of light guides each for causing surface emission of light received from at least one of the plurality of light sources,
the plurality of light guides being arranged so as not to overlap one another,
a light amount adjusting section for reducing an amount of light transmitted therethrough, the light amount adjusting section being provided between the light guides adjacent to each other.

4. The illumination device according to claim 1, wherein the light amount adjusting section is so provided on an end surface of each of the plurality of light guides as to cover the end surface, the end surface being located at a boundary between the light guides adjacent to each other.

5. The illumination device according to claim 1, wherein the light amount adjusting section is made of a semi-transmissive material for reducing an amount of light transmitted therethrough.

6. The illumination device according to claim 5, wherein the semi-transmissive material is gray ink.

7. The illumination device according to claim 1, wherein the light amount adjusting section has a function of reducing an amount of light transmitted therethrough and a function of reflecting light.

8. A liquid crystal display device comprising as a backlight an illumination device recited in claim 1.

9. The illumination device according to claim 2, wherein the light amount adjusting section is so provided on an end surface of each of the plurality of light guides as to cover the end surface, the end surface being located at a boundary between the light guides adjacent to each other.

10. The illumination device according to claim 3, wherein the light amount adjusting section is so provided on an end surface of each of the plurality of light guides as to cover the end surface, the end surface being located at a boundary between the light guides adjacent to each other.

11. The illumination device according to claim 2, wherein the light amount adjusting section is made of a semi-transmissive material for reducing an amount of light transmitted therethrough.

12. The illumination device according to claim 3, wherein the light amount adjusting section is made of a semi-transmissive material for reducing an amount of light transmitted therethrough.

13. The illumination device according to claim 11, wherein the semi-transmissive material is gray ink.

14. The illumination device according to claim 12, wherein the semi-transmissive material is gray ink.

15. (canceled)

16. The illumination device according to claim 2, wherein the light amount adjusting section has a function of reducing an amount of light transmitted therethrough and a function of reflecting light.

17. The illumination device according to claim 3, wherein the light amount adjusting section has a function of reducing an amount of light transmitted therethrough and a function of reflecting light.

18. A liquid crystal display device comprising as a backlight an illumination device recited in claim 2.

19. A liquid crystal display device comprising as a backlight an illumination device recited in claim 3.
